(19) United States
(12) Patent Application Publication
(10) Pub. No.: US 2005/0237059 A1
(43) Pub. Date: Oct. 27, 2005

(54) Method and apparatus for suppression of artifacts in MRT imaging

(76) Inventor: Arne Reykowski, Erlangen (DE)

Correspondence Address: SCHIFF HARDIN LLP;Patent Department, 6600 Sears Tower, 233 South Wacker Drive, Chicago, IL, 60606, US

(21) Appl. No.: 11/105,044

(22) Filed: Apr. 13, 2005

(30) Foreign Application Priority Data
Apr. 13, 2004 (DE) 10 2004 017 781.3

(51) Int. Cl. G01V 3/00

(52) U.S. Cl. 324/309; 324/307

(57) ABSTRACT

In a method and apparatus for suppression of artifacts in MRT imaging, individual signals are acquired at a first spatial point and at a second spatial point by a number of coils of a coil array. A combined signal composed of at least the individual signals of the first and second points is calculated using coil-dependent weighting factors for the individual signals and. Boundary conditions are established for the calculation of the combined signal such that an artifact is suppressed in the second point.

### FIELD OF THE INVENTION

The present invention concerns magnetic resonance tomography in general as it is applied in medicine for examination of patients, The present invention concerns a method as well as an apparatus for implementation of the method that enable suppression of artifacts in MRT imaging without large SNR (signal-to-noise ratio) loss.

### DESCRIPTION OF THE PRIOR ART

MRT is based on the physical phenomenon of nuclear magnetic resonance and has been successfully used as an imaging method for over 20 years in medicine and biophysics. In this examination modality, the subject is exposed to a strong, constant magnetic field. The nuclear spins of the atoms in the subject, which were previously randomly oriented, thereby align corresponding to the direction of the constant magnetic field.

Radio-frequency energy can now excite these “ordered” nuclear spins to a specific oscillation. In MRT, this oscillation generates the actual measurement signal that is acquired by appropriate reception coils. By the use of non-homogeneous magnetic fields generated by gradient coils, the signals from the examination subject can be spatially coded in all three spatial directions. This modality allows a free selection of the slice to be imaged, and slice images of the human body can be acquired in all directions. MRT as a slice imaging method in medical diagnostics is distinguished predominantly as a non-invasive examination method with a versatile contrast possibility. Due to the excellent ability to represent soft tissue, MRT has developed into a method superior in many ways to x-ray computed tomography (CT). MRT today is based on the use of spin echo and gradient echo sequences that achieve an excellent image quality with measurement times in the range of minutes.

The technical development of the components of MRT apparatuses and the introduction of faster imaging sequences continuous opens more fields of use to MRT in medicine. Real-time imaging to support minimally invasive surgery, functional imaging in neurology and perfusion measurement in cardiology are only a few examples. Despite the technical progress in the construction of MRT apparatuses, acquisition time and signal-to-noise ratio (SNR) of an MRT image remain limiting factors for many applications of MRT in medical diagnostics.

The spatial resolution of the resonance signal is based on the use of magnetic gradient fields. This means, however, the detection of a complete image data set requires a complete course of successive gradient coding steps. The speed of the data detection depends on the speed of the gradient coding, which in turn depends significantly on the strength and the switching frequency of the gradient fields that are used. The gradient power has been continuously improved in the past in order to satisfy the need for ever-faster imaging. However, this development is confronted with limitations since the cost of the gradient hardware has increased considerably, and switching the gradient coils too rapidly can affect the electrophysiology of the patient.

An alternative coding approach is known as parallel acquisition technique (PAT), in which a number of simultaneously operated reception coils are used in a specific arrangement. Elements of the arrangement are normally surface coils that exhibit a strong, non-homogeneous, different spatial sensitivity. The basis of the parallel acquisition technique is the fact that the influence of the coil sensitivity can be considered as producing a coding effect similar to gradient coding.

Using special reconstruction methods, which are normally algebraic methods, the measured signals are converted into image data. A problem with conventional image processing is to suppress or remove image artifacts, i.e. signal portions that, due to false spatial coding, are associated with an image pixel at which they were not generated.

Various approaches are known to address this problem. One possibility is to limit the field of view (FOV) or to extend the measurement times. Limiting the FOV is possible only to a certain extend, since an excessive limitation of the FOV in the phase coding direction leads to wrap-around artifact. Extending the measurement time does in fact improve the SNR; despite the longer measurement times that are often not desired, A reduction of the measurement time can, for example, reduce movement artifacts, but this is not always sufficient, or it occurs at the expense of the SNR.

A further method for suppression of artifacts makes use of saturation pulses. For this purpose, radio-frequency energy is additionally radiated into regions that should not appear on the later image. Since there is a limit for the total radiated energy, however, this limit value is reached faster due to the radiation of additional radio-frequency energy, which in turn is manifested in a degradation of the overall image quality.

Furthermore, the aforementioned methods have the disadvantage that they can only be used during the measurement, i.e. to directly influence the measurement and the measured signals. It is not possible to relieve images of artifacts after the underlying signals have been acquired.

### SUMMARY OF THE INVENTION

An object of the present invention is to provide a method and an apparatus for implementation of the method with which artifacts in MRT images can be removed without significantly reducing the overall image quality, and which can be applied additionally or alone at any time after the actual measurement.

The object is inventively achieved by a method for suppression of artifacts in MRT imaging which includes the steps of acquiring individual signals at a first spatial point and at a second spatial point with a number of coils of a coil array, calculating combined signal composed of at least the individual signals of the first and second points, using coil-dependent weighting factors for the individual signals, and establishing boundary conditions for the calculation of the combined signals, such that an artifact is suppressed in the second point.

Furthermore, according to the present invention an apparatus for implementation of a method for suppression of artifacts in MRT imaging, has a device for acquisition of individual signals at a first spatial point and at a second spatial point with a number of coils of a coil array, a device for calculation of a combined signal composed of at least the individual signals of the first and second points using coil-dependent weighting factors for the individual signals, and a device to establish boundary conditions for the calculation of the combined signals, such that an artifact is suppressed in the second point.

By the establishment of boundary conditions in the calculation of the overall signal from the individual signals, an artifact can be suppressed at selectively sought points without significantly reducing the quality of the remaining image. Furthermore, this method can be used after the actual measurement in order to selectively relieve the image of artifacts.

One boundary condition can be that the combined signal is maximal at the first point.

Another boundary condition can be that the combined signal is minimal at the second point.

Appropriately modified weighting factors are used for calculation of the combined signal such that both boundary conditions are fulfilled.

The modified weighting factors are applied only to regions with artifacts.

In an advantageous embodiment of the present invention, the inventive method or the inventive apparatus is combined with a parallel acquisition technique,

### DESCRIPTION OF THE DRAWINGS

FIG. 1 schematically illustrates an inventive MRT apparatus for implementation of the inventive method.

FIG. 2 schematically illustrates calculation of the combined signal in accordance with the invention without establishment of a boundary condition.

FIG. 3 schematically illustrates calculation of the combined signal in accordance with the invention with establishment of a boundary condition.

FIG. 4 illustrates sensitivity curves used in the inventive method and apparatus.

### DESCRIPTION OF THE PREFERRED EMBODIMENTS

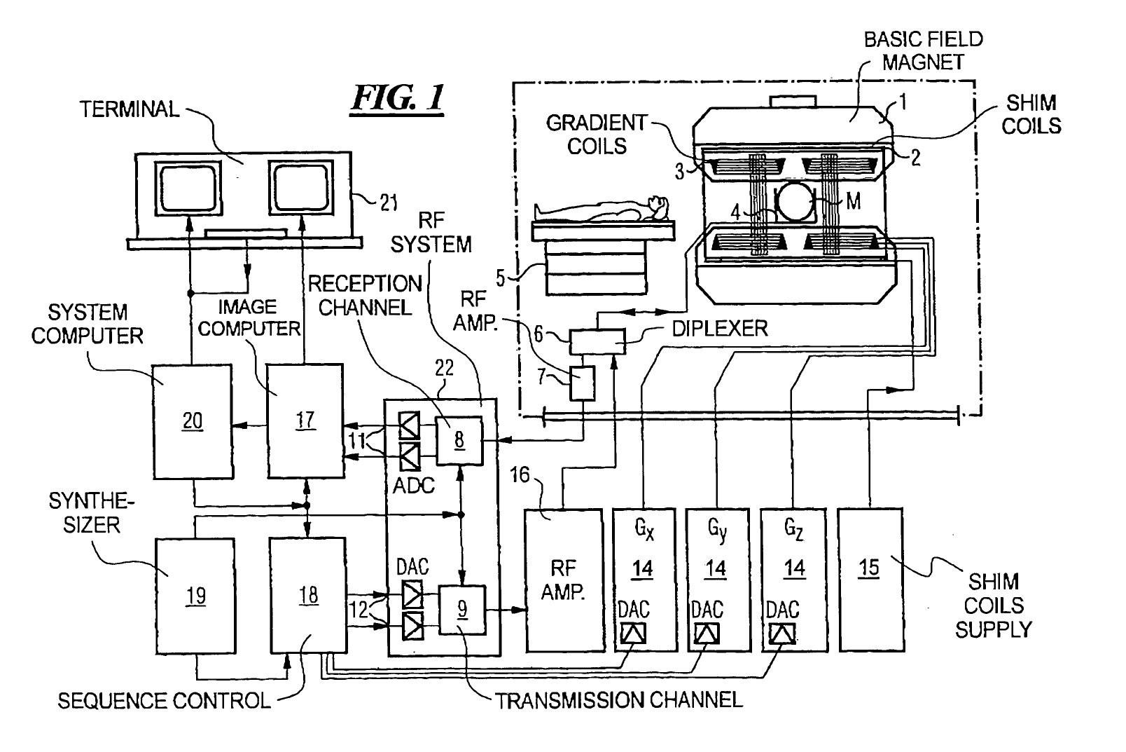

FIG. 1 schematically illustrates a magnetic resonance imaging or magnetic resonance tomography apparatus for generating a magnetic resonance image of a subject according to the present invention. The design of the magnetic resonance tomography apparatus corresponds to the design of a conventional tomography apparatus with the exceptions discussed below. A basic field magnet 1 generates a temporally constant strong magnetic field for polarization or alignment of the nuclear spins in the examination region of a subject such as, for example, a part of a human body to be examined. The high homogeneity of the basic magnetic field necessary for the magnetic resonance measurement is defined in a spherical measurement volume M in which the part of the human body to be examined is introduced. To support the homogeneity requirements, and in particular for elimination of temporally invariable influences, shim plates made from ferromagnetic material are mounted at a suitable location. Temporally variable influences are eliminated by shim coils 2 that are activated by a shim current supply 15.

A cylindrical gradient coil system 3 that is composed of a number of windings, known as sub-coils or sub-windings, is used in the basic field magnet 1. Each sub-coil is supplied with current by an amplifier 14 for generation of a linear gradient field in the respective directions of the Cartesian coordinate system. The first sub-coil of the gradient field system 3 generates a gradient Gₓ in the x-direction, the second sub-coil generates a gradient G_{y} in the y-direction and the third sub-coil generates a gradient G_{z} in the z-direction. Each amplifier 14 has a digital-analog converter that is activated by a sequence controller 18 for time-accurate generation of gradient pulses.

In MRT apparatuses, it is standard to use not a single coil but rather an arrangement composed of a number of coils. These component coils are connected to form a coil array and mutually overlap, so that likewise overlapping coil images can be acquired. Each coil requires its own receiver composed of a pre-amplifier, a mixer and an analog-digital converter.

Located within the gradient field system 3 is a radio-frequency antenna 4 that converts the radio-frequency pulses emitted by a radio-frequency power amplifier 16 into an electromagnetic alternating field for excitation of the nuclei and alignment of the nuclear spins of the subject to be examined, or of the region of the subject to be examined. The radio-frequency antenna 4 is formed by one or more RF transmission coils and a number of RF reception coils in the form of the already-specified linear arrangement of component coils. The alternating field originating from the precessing nuclear spins (i.e. normally the nuclear spin echo signals caused by a pulse sequence of one or more radio-frequency pulses and one or more gradient pulses) is also converted by the RF reception coils of the radio-frequency antenna 4 into a voltage that is supplied via an amplifier 7 into a radio-frequency receiver channel 8 of a radio-frequency system 22. The radio-frequency system 22 furthermore has a transmission channel 9 in which are generated the radio-frequency pulses for the excitation of the magnetic nuclear resonance. The respective radio-frequency pulses are digitally represented as a series of complex numbers due to a pulse sequence predetermined by the system computer 20. This number series is supplied as a real part and an imaginary part via respective inputs 12 to a digital-analog converter in the radio-frequency system 22 and, from this, to a transmission channel 19. In the transmission channel 9, the pulse sequences are modulated with a radio-frequency carrier signal whose base frequency corresponds to the resonance frequency of the nuclear spins in the measurement volume.

The switchover from transmission mode to reception mode ensues via a transmission-reception diplexer 6. The radio-frequency antenna 4 radiates the radio-frequency pulses into the measurement volume M for excitation of the nuclear spins and samples resulting echo signals. The acquired magnetic resonance signals are phase-sensitively demodulated in the reception channel 8 of the radio-frequency system 22 and translated into the real part and imaginary part of the measurement signal via respective analog-digital converters. An image is reconstructed by an image computer 17 from the measurement data so acquired. The administration of the measurement data, the image data and the control programs ensues via a system computer 20. Based on a requirement with control programs, the sequence controller 18 monitors the generation of the respectively desired pulse sequences. The sequence controller 18 controls the time-accurate switching of the gradients, the emission of the radio-frequency pulses with defined phase and amplitude and the receipt of the magnetic resonance signals. The time basis for the radio-frequency system 22 and the sequence controller 18 is provided by a synthesizer 19. The selection of corresponding control programs for generation of a magnetic resonance image as well as the representation of the generated magnetic resonance image ensues via a terminal 21 that has a keyboard as well as one or more screens.

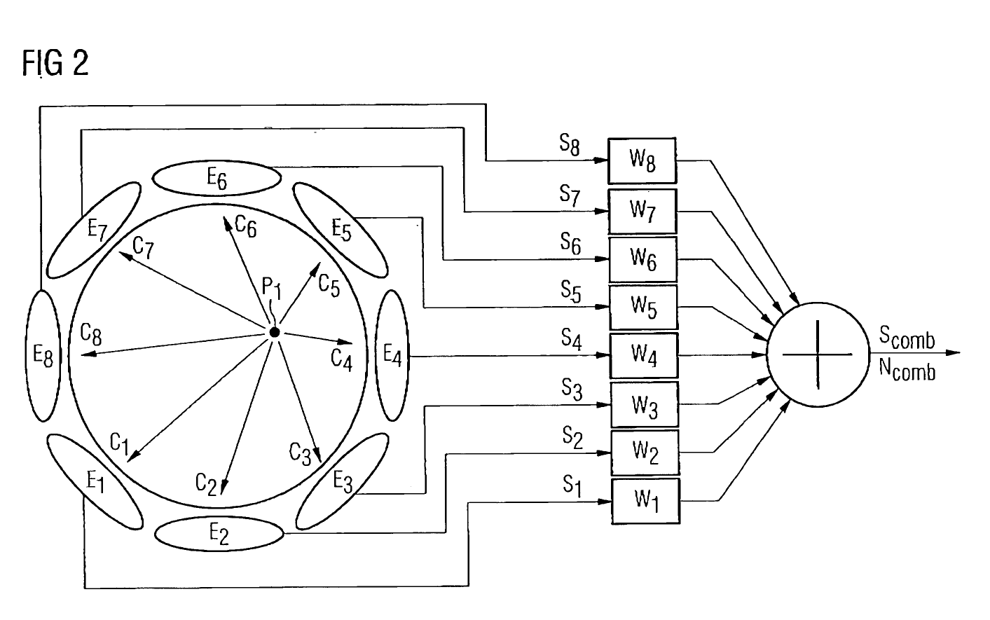

FIG. 2 schematic illustrates for acquisition and calculation of a signal at a first point P₁. A coil array composed of eight individual coils E₁ through E₈ acquires the signals S₁ through S₈ originating from the first spatial point. The signal S₁ is hereby acquired by the coil E₁ and the further signals Sᵢ are respectively acquired in an analogous manner by the corresponding coil Eᵢ. Dependent on the position of the respective coil E₁, a different sensitivity sector C₁ for the point P₁ can be associated with this coil. In order to arrive at a combined signal from the measured individual signals S₁ through S₈, the measured signals must be weighted by weighting factors w₁ through w₈. The combined signal-to-noise for a point P₁ thus results at

$${SNR}_{comb} = \frac{w \cdot S}{\sqrt{w \cdot R \cdot {w}^{H}}} \qquad ( 1 )$$

whereby S represents the signal vector comprised of the individual signals Sᵢ, w represents the weighting factor comprised of the weighting factors wₗ and R represents the noise correlation matrix. The optimal weighting factors result in a known manner from
wₒₚₜ=(C^{H}·R⁻¹) (2a)
whereby C is the sensitivity factor comprised of the individual sensitivities Cᵢ. Cᵢ is the sensitivity of the coil Eᵢ at the point P₁. The same applies for
wₒₚₜ=(S^{H}·R⁻¹) (2b)
due to the relationship S=l₀.C, whereby l₀ represents the image signal.

Using the optimal weighting factors, the optimal signal-to-noise can be calculated as
SNR_{comb}=\sqrt{S^{H}·R⁻¹·S} (3)

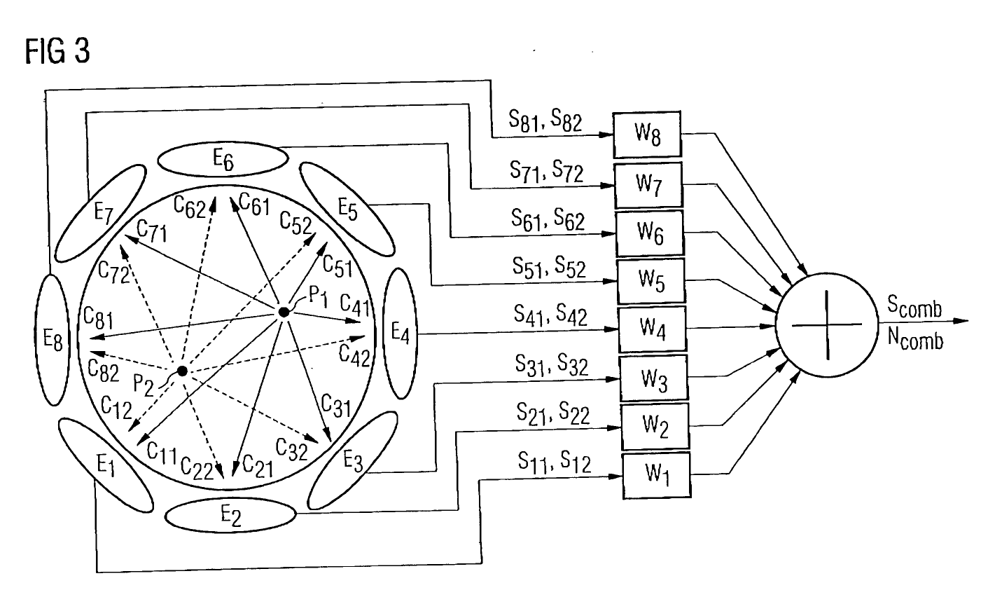

FIG. 3 analogously shows a schematic representation of the acquisition of signals at a first point P₁ and at a second point P₂ by the elements Eᵢ of the coil array. Signals Sₗⱼ are correspondingly acquired by the coil E₁ at the point Pⱼ. The signal S₄₁ thus corresponds to the signal that was acquired by the coil E₄ at the point P₁ with the sensitivity C₄₁. An optimal signal-to-noise SNRₒₚₜ can be calculated both for the first point P₁ and for the second point P₂.

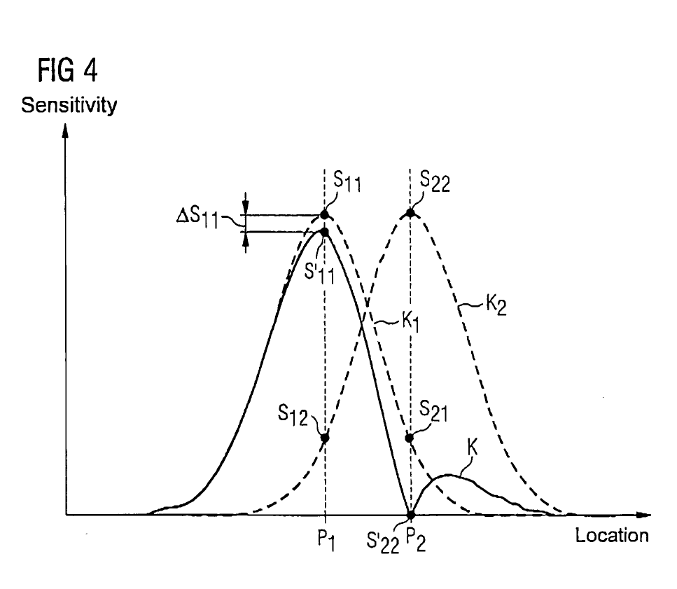

FIG. 4 shows examples of such combined signals. The location (in the present case the first point P₁ and the second point P₂) is plotted along the abscissa. The ordinate indicates the combined signal distribution. The dashed curve K₁ hereby shows the combined signal at the point P₁. The combined signals was calculated using the optimal weighting factors, such that the signal is maximal at the point P₁. Furthermore, the dashed curve K₂ shows the combined signal at the point P₂ that was likewise calculated using the optimal weighting factors.

In order to now suppress an artifact at the point P₂, according to the inventive method two boundary conditions are established for the calculation of the overall signal. The overall signal should be maximal at the first point P₁; the overall signal should be suppressed at the point P₂, meaning that the signal should be zero. To fulfill these conditions, a modified weighting factor w_{mod} is inserted which is composed as follows:

$${w}_{mod}^{( 1 )} = {w}^{( 1 )} - {w}^{( 2 )} \cdot ( \frac{{S}^{( 2 )} \cdot {w}^{( 1 )}}{{S}^{( 2 )} \cdot {w}^{( 2 )}} ) \qquad ( 4 )$$

The factors w^{(j)} are the unmodified weighting factors for the reconstruction of signals at the location Pⱼ and S^{(j)} is the signal vector of all signal portions Sₗ at the location Pⱼ. Both boundary conditions are fulfilled by the use of this modified weighting factor in the calculation of the overall signal, meaning that it is

$${S}^{( 2 )} \cdot {w}_{mod}^{( 1 )} = 0 \qquad ( 5 )$$

and thus the signal is equal to zero at the location P₂, and moreover the combined signal at the location P₁ is maximal under the given boundary conditions. This fact is likewise to be learned from FIG. 4. The solid curve K hereby represents the combined signal under inclusion of both boundary conditions. It is visible that the combined signal K is zero at the point P₂ and maximal at the point P₁. The signal loss ΔS₁₁ is produced by the artifact suppression at the point P₂.

By the introduction of a modified weighting factor which is only tied to the first point P₁ and to the second point P₂, selective artifacts can be suppressed at the point P₂ and simultaneously the signal intensity can be maximized at the point P₁ without the image being influenced in terms of its overall quality. Furthermore, the proposed algorithm can also be applied to a number of points of an image.

Although modifications and changes may be suggested by those skilled in the art, it is the intention of the inventor to embody within the patent warranted hereon all changes and modifications as reasonably and properly come within the scope of his contribution to the art.

1. A method for suppressing artifacts in magnetic resonance tomography imaging, comprising the steps of:
acquiring magnetic resonance signals respectively at a first spatial point of an examination subject and at a second spatial point of an examination subject using a plurality of reception coils in a coil array, each of said coils having a coil-dependent weighting factor associated therewith;
weighting said magnetic resonance signals with said coil-dependent weighting factors to obtain weighting signals, and electronically calculating a combined signal from said weighted signals; and
in calculating said combined signal, employing boundary conditions for suppressing an artifact at said second spatial point.

2. A method as claimed in claim 1 comprising requiring, as a first of said boundary conditions, that said combined signal be maximal at said first spatial point.

3. A method as claimed in claim 2 comprising requiring, as a second of said boundary conditions, that said combined signal be minimal at said second spatial point.

4. A method as claimed in claim 3 comprising modifying said weighting factors to fulfill said first and second of said boundary conditions.

5. A method as claimed in claim 4 comprising applying said modified weighting factors only to magnetic resonance signals from a region of said subject exhibiting said artifact.

6. A method as claimed in claim 1 comprising acquiring said magnetic resonance signals using a parallel acquisition technique.

7. A magnetic resonance tomography imaging apparatus, comprising the steps of:
a magnetic resonance scanner adapted to interact with a subject therein to acquire magnetic resonance signals respectively at a first spatial point of the subject and at a second spatial point of the subject using a plurality of reception coils in a coil array, each of said coils having a coil-dependent weighting factor associated therewith;
a computer to which said magnetic resonance signals are supplied that weights said magnetic resonance signals with said coil-dependent weighting factors to obtain weighting signals, and electronically calculates a combined signal from said weighted signals; and
said computer, in calculating said combined signal, employing boundary conditions for suppressing an artifact at said second spatial point.

8. An apparatus as claimed in claim 7 wherein said computer, as a first of said boundary conditions, requires that said combined signal be maximal at said first spatial point.

9. An apparatus as claimed in claim 8 wherein said computer, as a second of said boundary conditions, requires that said combined signal be minimal at said second spatial point.

10. An apparatus as claimed in claim 9 wherein said computer modifies said weighting factors to fulfill said first and second of said boundary conditions.

11. An apparatus as claimed in claim 10 wherein said computer applies said modified weighting factors only to magnetic resonance signals from a region of said subject exhibiting said artifact.

12. An apparatus as claimed in claim 7 wherein said scanner acquires said magnetic resonance signals using a parallel acquisition technique.
